(19) United States
(12) Patent Application Publication
(10) Pub. No.: US 2015/0121195 A1
(43) Pub. Date: Apr. 30, 2015

(54) CONTENT DISPLAY

(71) Applicants: Darryl Greig, Fishponds Bristol (GB); Andrew Hunter, Bristol (GB); Sean Sutton, Bridgwater (GB)

(72) Inventors: Darryl Greig, Fishponds Bristol (GB); Andrew Hunter, Bristol (GB); Sean Sutton, Bridgwater (GB)

(21) Appl. No.: 14/391,214

(22) PCT Filed: Jun. 29, 2012
(86) PCT No.: PCT/EP2012/062784

§ 371 Date: Oct. 8, 2014

(51) Int. Cl. G06F 17/21; G06F 17/22

(52) U.S. Cl. CPC G06F 17/212; G06F 17/2247
USPC 715/234

(57) ABSTRACT

The present invention relates to a system 10 for generating a content hierarchy 12 for use in laying out content from a source 14 for display. The system comprises a content gatherer 16 co-operable with a source for gathering content from the source into content sub-groups dependent on the content type of the content; a design fragment populater 24 for populating at least one design fragment 19 using the gathered source content, the plurality of design fragments each comprising design parameters specifying how the source content can be laid out; and a content hierarchy assembler 32 for attaching the populated design fragment to a selected parent fragment 19 permitted for the populated design fragment, the parent fragment containing design parameters specifying how each design fragment can be laid out for display.

### FIELD OF INVENTION

The present invention relates generally to laying out content for display.

### BACKGROUND OF INVENTION

There are many different contexts in which digital content must be gathered and laid out efficiently and effectively in order to be attractive to and easily consumed by the widest possible audience. As an example, the activity of an individual user of a social networking site and their close friends can be extremely difficult to summarize in a form that is readable, aesthetically pleasing and conveys the most salient content. While technologies for aggregating and summarizing content have improved, the methods used for automatically laying out such content for the purposes of high quality output such as printed output have not kept pace.

There are multiple different types of content with and without metadata, including for example text, graphics, images, video and audio, and each of these content types may be augmented with captions, comments, links, ratings and other adornments to form complex groupings of associated content, for example as a grouping of content associated with a status update of a social networking site. For convenience we will refer to these associations of contents simply as content.

Known techniques for laying out and displaying content include template solutions and solutions based on layout engines.

Template-based solutions have a single, fully defined template into which the content is inserted. These solutions have very limited flexibility in responding to variations in the source content. In order to accommodate such variations either a large library of templates covering a wide range of possible source content configurations is necessary, or else very stringent requirements must be enforced on the source content.

Layout engine based solutions map content to layouts using layout algorithms that are each designed to handle pre-defined generic types of content. These solutions are typically less visually complex than template-based solutions, but are significantly more adaptable to varying amounts of content. Layout engine based solutions do not handle varying streams of multiple types of source content well.

### SUMMARY OF INVENTION

The present invention provides a system for generating a content hierarchy for use in laying out content from a source for display, the system comprising: a content gatherer co-operable with a source for gathering content from the source into content sub-groups dependent on the content type of the content; a design fragment populater for populating at least one design fragment using the gathered source content, the plurality of design fragments each comprising design parameters specifying how the source content can be laid out; and a content hierarchy assembler for attaching the populated design fragment to a selected parent fragment permitted for the populated design fragment, the parent fragment containing design parameters specifying how each design fragment can be laid out for display.

The present invention also provides a method for generating a content hierarchy for use in laying out content from one or more sources for display, the method comprising: gathering content from a source; populating at least one design fragment from a plurality of stored design fragments using the gathered source content, the plurality of design fragments each comprising design parameters specifying how the source content can be laid out; and assembling the content hierarchy by attaching the populated design fragment to a selected parent fragment permitted for the populated design fragment, the parent fragment containing design parameters specifying how each design fragment can be laid out for display.

The present invention also provides a computer readable medium having a computer program recorded thereon, the program being executable by a computer to carry out the above method.

The present invention also provides computer apparatus comprising a processor programmed to perform the method.

### BRIEF DESCRIPTION OF DRAWINGS

In order that the present invention may be well understood, some embodiments thereof, which are given by way of example only, will now described with reference to the accompanying drawings, in which:

FIGS. 1A to 1D show a system for generating a content hierarchy;

FIG. 2 shows a first application of the system shown in FIGS. 1A to 1D;

FIG. 3 shows a second application of the system shown in FIGS. 1A to 1D;

FIG. 4 shows a third application of the system shown in FIGS. 1A to 1D; and

FIG. 5 shows a fourth application of the system shown in FIGS. 1A to 1D.

### DETAILED DESCRIPTION OF EMBODIMENTS

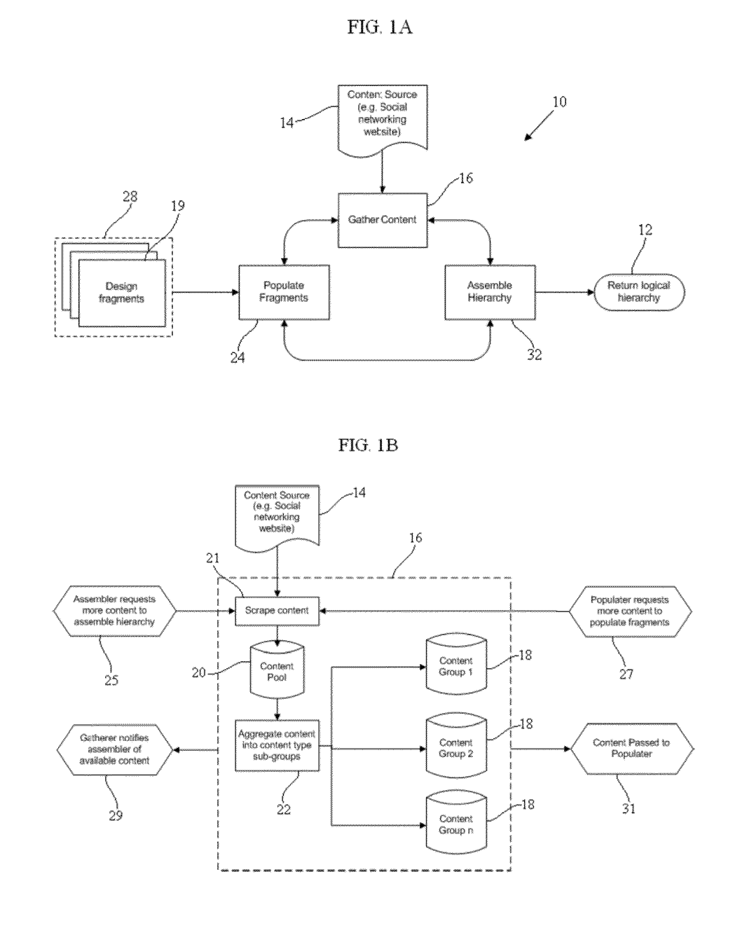

Referring to FIG. 1A to 1D, a system 10 is shown for generating a content hierarchy 12 for use in laying out content from a source 14 for display. The content hierarchy contains sufficient information for layout engines to layout content in any of one of a plurality of different media or designs and without requiring any further knowledge about the content. The information may be sufficient to constrain the layout to a single valid design or may allow multiple designs that are valid such that the content can be fitted flexibly by the layout engines to different display surfaces. In this sense, the content hierarchy is a display independent format. The content hierarchy has a generally tree-like structure with branches that represent parent content that split into sub-branches that represent child contents. Those child branches can split into further sub-branches that represent grandchild content and so on. The tree structure thereby describes the grouping and nesting of content that would be reflected in any eventual layout. Those skilled in content layout will appreciate that although the structure has a generally tree-like structure, there may be additional structures and relationships between contents that have the more general form of a graph. The term content hierarchy is used to describe the content structures and relationships whether or not they have a purely tree-like form.

The system is arranged to generate automatically a logical hierarchy of content from one or more sources containing multiple types and structures of source content. The resulting hierarchy self-assembles based on the source content supplied, and on designer supplied design fragments. The method can be further enhanced by system or designer supplied heuristics that balance the various content types on a particular output surface and manage flow across multiple surfaces. That is, a sequence of pages or spreads (output sequences) can be composed by the system so that the different content types are spread across those pages in an aesthetically pleasing way (i.e. a pleasing mix of images and text on each page) rather than visually indigestible chunks of homogeneous content on each page. Although the system described here is intended to generate automatically a content hierarchy for display, further enhancements are possible by those skilled in the art to enable the content, design fragments, hierarchy and layouts to be selected or modified by user interaction.

The content source or sources 14 which contain content can be of different types, for example the source may be a file on a local computer such as a picture file containing images for display together with metadata associated with the images such as date, location or subject-matter. In a preferred example, the source is a website such as a social networking site. In this regard, the content may be images, text, graphics, user information, or even statistics on user activity. The activity of an individual user and their close friends can be extremely difficult to summarize in a form that is readable, aesthetically pleasing and conveys the most salient content over a specified time period. The system 10 enables a user to aggregate and summarize content for automatically laying out such content for the purposes of high quality display, whether for digital display or printed output.

FIG. 1A shows an embodiment of the invention and FIGS. 1B to 1D an arrangement of the parts shown in FIG. 1. Referring particularly to FIG. 1A, the system comprises a content gatherer 16, a populator 24 and an assembler 32 for generating a content hierarchy for use in laying out content from one or more sources 14 for display. The content gatherer 16 gathers content from the source 14. The populator 24 populates at least one design fragment from a plurality of stored design fragments using the gathered source content. The design fragments comprise design parameters specifying how the source content can be laid out. The assembler 32 assembles the content hierarchy by attaching the populated design fragments to a selected parent fragment permitted for the populated design fragment. The parent fragment contains design parameters specifying how each design fragment can be laid out for display.

In the FIG. 1A arrangement, the gatherer 16, populator 24 and assembler 32 can communicate with each other in both directions as shown by the arrows in the drawing. The gatherer can send gathered content or other data relating to the gathered content to the populator and assembler and can gather content from a source dependent on requests received from the populator and assembler. The populator can populate design fragments using content received from the gatherer and can send requests for content to the gatherer. The populator can send populated design fragments to the assembler and can generate design fragments dependent on requests received from the assembler. The assembler can receive populated design fragments from the populator and send requests for design fragments to the populator. The assembler can receive data relating to gathered content from the gatherer and can send requests to gather content to the gatherer.

In other arrangements, the communication represented by one or more of the arrows in FIG. 1A may be omitted provided that gathered content can populated into design fragments by the populator and design fragments can be assembled by the assembler.

In an example of the FIG. 1A arrangement, the content gathered initially comprises a number of images taken from the posts of an individual user of a social networking site. The gatherer communicates that images have been gathered to the assembler or the populator. Either the assembler or the populator may request that the gatherer gathers textual content associated with the images, such as comments from other users relating to the user's images. Alternatively, the gatherer may in the first instance gather all available content associated with the images. The assembler may commence generation of the hierarchy on the basis that a specified number of images and associated text will be received wrapped in the appropriate design fragments and request an appropriate parent fragment to contain these design fragments. The populator instantiates a required number of design fragments using the gathered content and outputs the fragments for use by the assembler. It will be appreciated therefore that control of the process can be centred on one of the gatherer, populator or assembler, or control may be distributed amongst more than one or all of the parts.

One example of the content gatherer 16 will now be described in more detail with reference to FIG. 1B. The illustrated content gatherer 16 is co-operable with the source 14 for aggregating content from the source into content sub-groups 18 dependent on the content type of the content. The content gatherer comprises a content scraper 21 for scraping the content if the content is stared by a website. The content is arranged in a logical manner by the website and the content gatherer is configured to access the content according to the logical arrangement so that the content can be readily gathered from the website. In this regard, the scraper 21 comprises an external application programming interface, or API, which describes a method of extracting particular content from a source. For example, a particular social networking site comprises an API which allows a calling application to extract all status updates, together with associated comments, metadata and “likes”. In an initial step, the content gatherer 16 retrieves the content from the website and stores it in a content pool 20.

In this embodiment, all the source content available for the content hierarchy is aggregated by a content aggregator 22 from the content pool 20 into suitable sub-groups representing respective content types, for example a “status updates” content subgroup or a “posts” content subgroup, each containing one or more data types such as pictures, comments or other data. In some cases, the content of subgroups can be derived from previously created subgroups i.e. containing content not directly available from the source. An example of this content type subgroup is a “usage statistics” content group. There may be any number of sub-groups from a single group to ‘n’ groups, as shown in FIG. 1B.

The content gatherer may be arranged to aggregate content from a plurality of sources. In a preferred example of this arrangement, the sources are different social networking sites or a combination of social networking or other sites and local files. A user may have content to be gathered located on multiple different sites and it is useful to combine such content in a single user readable and appealing document. Alternatively content stored locally by a user can be gathered and aggregated with content stored by a social networking site. The content gatherer may also be arranged to aggregate, merge and derive new content from the source content. For example, the gatherer might derive statistical information relating to the source content and might include the statistical information as additional content for use in populating design fragments.

In one example where the source is a file containing photographic images, a sub-group 18 may include one or more of those images grouped according to a time period over which the photographs were taken together with user supplied descriptions associated with each of the photographs. In another example, a social networking website may contain means by which a user of the website can input user originating information with images or text, or comment on the inputs of other users. When the content originates from multiple sources the content gatherer will use APIs for each of those sources and will flow content of similar intent into a single content type. For example, images (plus metadata, comments etc) from one source may be assigned the same internal type as images (with metadata, comments) from another source, and the gatherer will be responsible for scraping and formatting the website data into the internal data structures necessary to define the content types. A content sub-group 18 in this case may comprise photographic images taken over a specified time period (e.g. a user's birthday) together with textual inputs from the user and the inputs of other users relating to the photographic images. In each case, the sub-group 18 contains content having an association and when the content is displayed the association is preserved as explained in further detail below.

The content scraper 21 is arranged to receive requests 25, 27 from the populator 24 and the assembler 32 to gather content from a source. For example, the populator may request additional content for populating a design fragment and the assembler may request content for assembling an additional design fragment in the hierarchy. The gatherer 15 is arranged to communicate data 29 relating to the content gathered to the assembler, for example the number of images that have been gathered for a “post”. The content gathered from a source is passed to the populator at step 31 for population in a design fragment as described in more detail with reference to FIG. 1C.

One example of the populator 24 will now be described in more detail with reference to FIG. 1C. The design fragment populater retrieves content from the content subgroups 18 as indicated by reference numeral 33. A plurality of design fragments 19 are stored in the design fragment store 28 for pairing with content of a particular content type. A design fragment is defined as a pre-designed sub-hierarchy that may be thought of as a flexible template for content from a particular content type, or a container for other elements in the content hierarchy. A design fragment is instantiated when it is used as a pattern to create an element suitable for the content hierarchy. It is populated when it is both instantiated and any content slots are populated with available content of the necessary type.

At step 30, a design fragment is populated for the content of the first content subgroup 18. The design fragment to be populated is selected dependent on the content type of the subgroup. The design fragment comprises design parameters, specifying or constraining how the content from the sub-group can be structured and laid out for display. The content is therefore paired with design parameters in a discrete design fragment for insertion into the content hierarchy.

A fragment may be populated by a particular source content instance through a defined interface. For example, the fragment may include the name of the content author, the date of authorship, an associated image and a description. The interface extracts this data from the source content instance and uses it to initialize the fragment.

The design parameters for displaying the content of a sub-group are independent of the media of display or the design of the media. In the case where a subgroup 18 contains images and text the design parameters will specify how this content can be laid out in a final document. The design parameters give enough information that when laid out by the appropriate layout engines the final effect will be consistent with what the designer intended. For example, the parameters may specify that a block of text associated with an image is laid out adjacent the image and in a display region having minimum width to allow the text to be readable and aesthetically appealing. There may be restrictions on the size of the image or that the aspect ratio must be maintained. The display region for displaying all the content of a subgroup may have a minimum size or may be required to be in a specified region of a document. The design fragment may also include other text, graphic or image components independent of the content that are purely to decorate or clarify the final design.

The sub-groups of source content are accessed according to a predetermined sampling strategy for example, taking content from each sub-group in sequence and iterating. In another example, the design fragment composes a page with 30% images and 70% text, or all text and images associated with a particular date or event. Each fragment is associated either with a single content type, or is part of the parent hierarchy of a content type. A content type could have sophisticated content, such as a status update with comments, likes, links, dates, ratings, images, etc, all of which are accommodated (or ignored) by the fragment associated with that content type.

Typically, content from any given sub-group 18 is paired with a single design fragment but the content can be paired with a plurality of design fragments. This approach may be appropriate where its content has multiple occurrences in a document and different design parameters are to be applied to the content depending upon its occurrence.

As indicated by reference numerals 35, the populator is arranged to communicate with the gatherer 16 to request further content and to receive requests 37 from the assembler to populate or instantiate design fragments. The populated design fragments are passed to the assembler as indicated by reference numeral 39 for assembling the hierarchy as described in more detail with reference to FIG. 1D.

One example of the assembler 32 will now be described in more detail with reference to FIG. 1D. The content hierarchy assembler 32 assembles the content hierarchy 12 by attaching the populated design fragment paired with content from the first subgroup to a selected parent fragment permitted for the populated design fragment. Parent fragments contain design parameters, or constraints, at a higher level in the content hierarchy and specify how each design fragment can be laid out for display within the constraints of any particular layout engine. For example, the parent fragment may specify the required spacing between two design fragments. A plurality of parent fragments is stored in fragment store 28 and each populated design fragment can be attached only to an appropriate parent fragment or in some cases more than one appropriate parent fragment.

A design, or child, fragment is paired with a fragment type as a logical parent. A fragment arranges its logical children into a content structure that meets the intention of the designer. The logical children of a fragment can be either data extracted from the source content instance, other source content such as text and graphics inherent to the fragment or extracted from a third party source, or other fragments.

When a design fragment is populated for content of a subgroup, the design fragment contains attributes specifying one or more parent fragment types to which the design fragment is permitted to be attached in the content hierarchy. Additionally, or in an alternative, each parent fragment comprises attributes specifying the type of child fragment to which the parent fragment can be attached and/or the number of child fragments to which the parent fragment can be attached. For example, a fragment may allow no more than 4 landscape image children and no other content.

A design fragment can be attached to a parent fragment in one of two ways dependent on whether or not a suitable parent fragment is already instantiated in the existing content hierarchy 12. In a first method, a parent locator 41 of the content hierarchy assembler 32 is arranged to assemble the content hierarchy by locating in the existing content hierarchy a parent fragment which is permitted for the populated design fragment and attaching the populated design fragment to the permitted parent fragment. In a second method, the content hierarchy assembler is arranged to assemble the content hierarchy by first sending a request 43 to populator for instantiating a parent fragment permitted for the populated design fragment if such a permitted parent fragment cannot be located in the existing content hierarchy and attaching the populated design fragment to the permitted parent fragment.

Depending on the design constraints of the required hierarchy, the assembler determines at step 45 if sufficient design fragments are contained in the hierarchy and may send one or more additional requests 43 to the populator for additional design fragments if the hierarchy has insufficient fragments. If the determination is positive the design fragments are assembled into the hierarchy 12 at step 47. Additionally, the assembler determines at step 49 if sufficient content has been populated into design fragments for the requirements of the hierarchy. For example, the hierarchy may require that all images are accompanied by associated text. If associated text has not been supplied, the assembler sends a request 51 to the gatherer 16 to look for the associated text.

The content hierarchy assembler 32 is arranged to assemble the content hierarchy by attaching parent fragments to further parent fragments rising to higher levels in the content hierarchy until an instantiated parent fragment is attached to a root fragment of the content hierarchy. The pairing of the source content with a fragment type (through an interface) initiates the self-assemblage process of the content hierarchy. This process proceeds by populating the fragment, then either attaching the fragment to an existing parent fragment in the current hierarchy, or, if no suitable parent fragment exists, creating a suitable parent fragment. This process iterates until one of the parent fragments in the chain is attached to an existing root fragment, or until a new root document fragment is created. Every fragment (with the exception of the root fragment) must have one or more chains of parent fragment types that ultimately conclude at the level of the parent document (the root fragment). In a modification, an populated fragment can be copied (along with its sub-hierarchy) and the copy attached to a second root.

In this way, a design fragment is paired with content from a subgroup specifying how the content can be structured and laid out for display, typically at a lowest level in the hierarchy. The design fragment is attached to a parent, or container, fragment at a higher and typically next level that specifies how different design fragments can be structured and laid out for display. A next level in the hierarchy may contain parent fragments, or content manager fragments, which may specify certain characteristics of a final layout such as column width or row height of a page. A next level in the hierarchy may have pre-defined structured content of its own that does not require population with gathered content from a content source. A next level may also have slots for additional content to be gathered from a content source. A next level in the hierarchy may have parent fragments which have properties which relate to a full document, such as page numbers, headings etc. A root document fragment will typically contain properties which specify how different lower level fragments can be arranged in an overall document. Different root fragments in the hierarchy may relate to different types of document. The process may generate more than one content hierarchy which are distinct from one another.

When content from a first sub-group 18 has been processed and contained within the logical hierarchy 12 as described above, the assembler checks for further subgroups at step 53. In the present example, further subgroups are available and therefore the content of a second sub-group 18 is retrieved from the content gatherer 16. The process is repeated and a suitable design fragment is populated for the next content and that design fragment is attached to parent fragments in the hierarchy rising higher until the chain is attached to one or more root fragments. The design fragment populater 24 retrieves subsequent content in this way from further sub-groups until all of the content from sub-groups has been either discarded, or processed and included in the logical hierarchy.

At each content addition the content hierarchy can be laid out incrementally by suitable layout engines to ensure that the final layout will always meet its layout constraints as well as the designer intent.

Fragment hierarchies are assumed to compose coherent final content hierarchies, so it is possible to use the same content in several documents with different end purposes for example, image content may be combined with other content for a newsletter, and at the same time be used to create a photo-album. Alternatively several documents of the same type (say a newsletter) but with a different theme (say “modern”, and “classic”) could be produced from the same source content.

The embodiment shown in FIG. 1 provides a number of additional advantages.

The result of the process herein described is one or more documents encapsulating at least a subset of the supplied source content in a layout-agnostic logical hierarchy. The layout engines responsible for the arrangement of each fragment may then be called to produce the final laid-out document.

Using appropriate manual and/or automatic technologies the fragments themselves could be generated from a suitable source document that consists of a laid-out instantiation of one collection of content. Thus the fragment creation step becomes a minimal overhead on top of a standard design task.

The embodiment accommodates a wide variety of source content types through simple interfaces. Only the logical structures required to accommodate an actual set of source data are added to the hierarchy unlike prior art solution which sometimes supply “holes” or “stubs” in the target document template which must then be dealt with through some post-processing if unappealing unpopulated locations are to be avoided. A single pool of source content can easily be used to produce multiple output documents in varying styles or for varying purposes.

Fragment designs may omit or add data defined by the interface as needed. For example some image content may include descriptions or comments that can optionally be included (or omitted) in fragment designs paired with that content type.

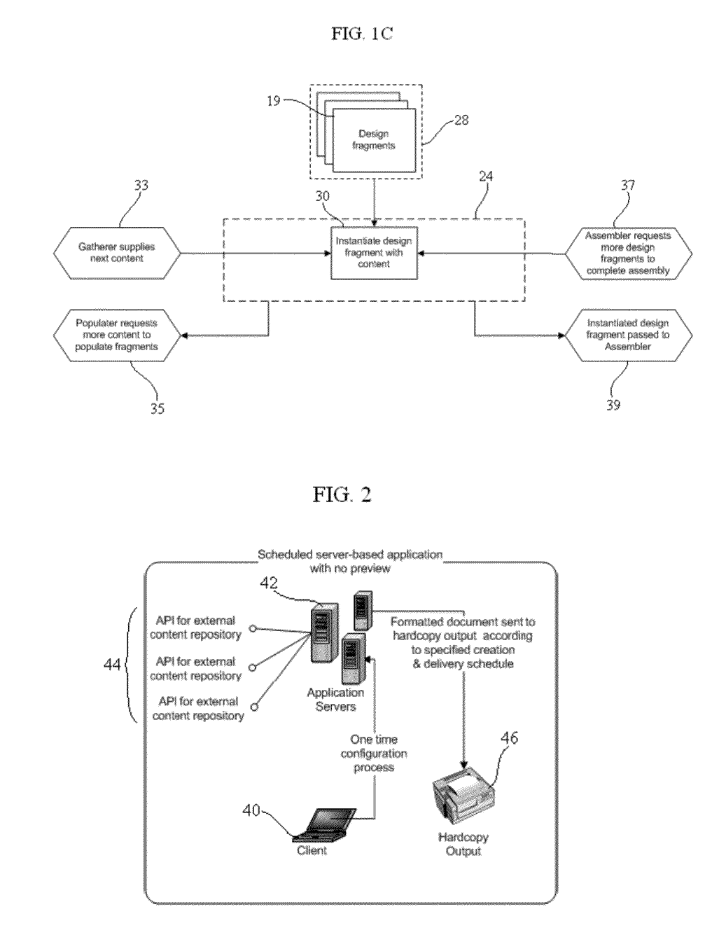

FIG. 2 shows a server based application in which the application server is configured according to the method 10. The method is carried out by processors and electrical components under the control of computer readable and computer executable instructions stored on a computer-usable storage medium. The computer readable and computer executable instructions reside, for example, in data storage features such as computer usable volatile and non-volatile memory. The computer usable medium may be non-transitory. However, the computer readable and computer executable instructions may reside in any type of computer-usable storage medium.

In this application, a client 40 (for example a user's local machine) connects to an application server arrangement 42 comprising one or more servers and requests scheduled delivery of a formatted document for printing containing content gathered from a source such as a social networking site. The user can configure the process specifying for example the time periods for document delivery or if document delivery is triggered by predetermined activity on a user's account. The user can also specify what content is to be gathered for example that only status updates are to be gathered. The design of the delivered document can also be selected but the final delivered document will at this configuration stage be unknown and dependent on the content which is gathered from time to time.

When scheduled, the application server 42 retrieves content from one or more sources through associated APIs 44 for storage in a content pool 20 of the server. The application server comprises a content gatherer 16 which aggregates the source content into subgroups 18 and design fragment populater 24 which pairs successive content types with design fragments for generation of a content hierarchy by a content hierarchy assembler 32. The application server may comprise one or more layout engines for laying out a formatted document dependent on the generated content hierarchy. More than one formatted document can be produced with different designs or for different types of printed output using the content hierarchy. The application server sends a formatted document directly to the networked printer 46 for printing without prior review by the user. Other hardcopy output such as a storage medium containing the formatted document can be sent to the user. The printer is typical local to the client 40, although a service in which documents are printed and then forward to the user through a hardcopy mailing system may also be envisaged. Further formatted documents will subsequently be printed according to the schedule and with updated content from the source.

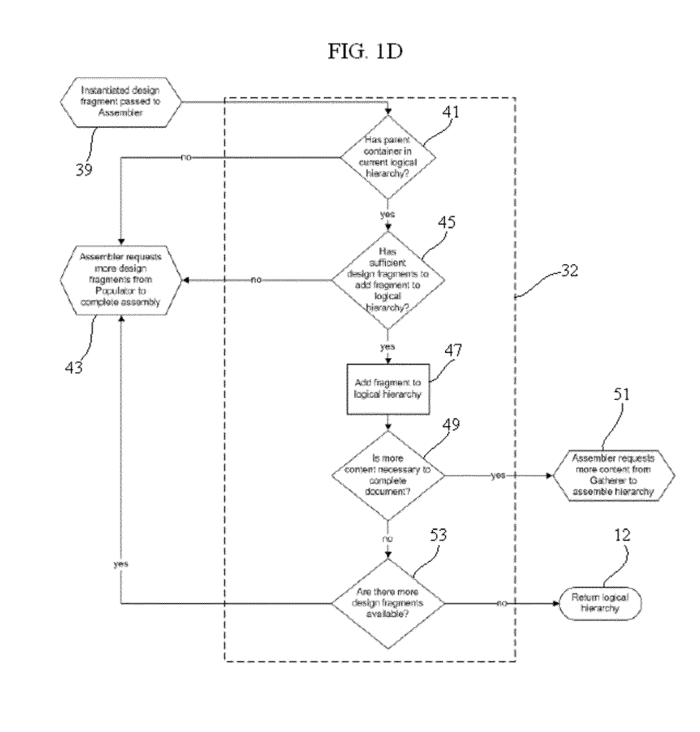

The application shown in FIG. 3 is similar to that shown in FIG. 2 except that when scheduled, content from a source is gathered and a content hierarchy generated. A formatted document based on the content hierarchy is then sent to the client 40 for preview. If approved, the user can print the document at a connected printer 46 or store the document digitally for subsequent printing or for sending over a network. If changes to the document are required, those changes can be requested and a revised document formatted. The revised document will be based on the same content hierarchy as the original document although a layout engine will lay out content in different way. When finally approved the document can be printed, stored or sent.

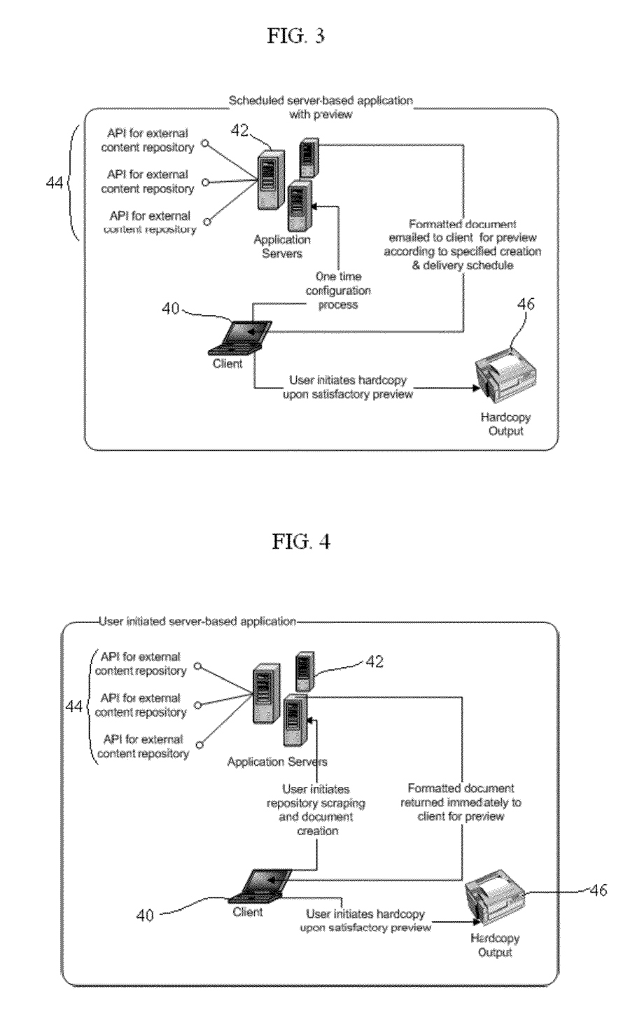

The application shown in FIG. 4 is similar to that shown in FIG. 3, except that it is an on-demand application in which the user initiates the process described in relation to FIG. 3 rather than the process being scheduled. In the FIG. 4 application, a user's local machine 40 requests document creation which triggers content scraping of a source via the APIs and pooling in content pool 20. Once a content hierarchy is generated and a document formatted it is immediately sent to the user machine for user approval. As with the FIG. 3 application the document can be changed and re-issued, stored, sent or printed.

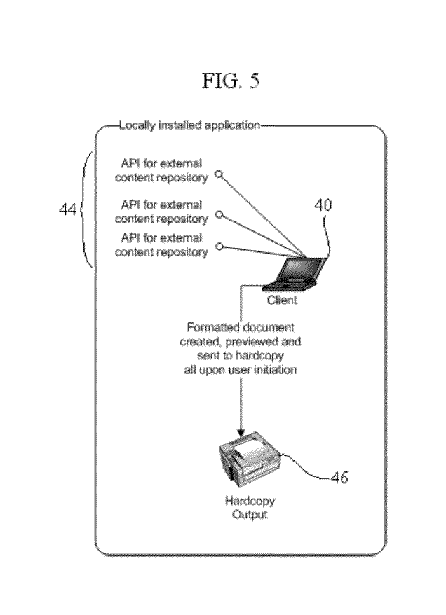

FIG. 5 shows a user's local machine configured according to the system 10. The user can install the system by downloading it over a network or from a computer-readable material including program instructions according to the system. The system operates in a similar way to FIG. 4 in that it is an on-demand system in which a user initiates content retrieval from a source and the content hierarchy is generated locally on the user's machine. Once document formatting has been completed, the document can be changed, stored, sent or printed, as above.

In an alternative application (not shown), the system 10 may be located on a server of a social networking site and accessed by a user remotely. In this case, the social networking server is configured according to the application servers as described in any one or more of FIGS. 2 to 5.

1. A system for generating a content hierarchy for use in laying out content from a source for display, the system comprising:
a content gatherer co-operable with a source for gathering content from the source into content sub-groups dependent on the content type of the content;
a design fragment populater for populating at least one design fragment using the gathered source content, the plurality of design fragments each comprising design parameters specifying how the source content can be laid out; and
a content hierarchy assembler for attaching the populated design fragment to a selected parent fragment permitted for the populated design fragment, the parent fragment containing design parameters specifying how each design fragment can be laid out for display.

2. A system as claimed in claim 1, wherein the content hierarchy comprises a parent locator and the assembler is arranged to assemble the content hierarchy by locating in the existing content hierarchy a parent fragment permitted for the instantiated design fragment and attaching the instantiated design fragment to the permitted parent fragment.

3. A system as claimed in claim 1 or 2, wherein the content hierarchy assembler is arranged to assemble the content hierarchy by instantiating a parent fragment permitted for the instantiated design fragment if such a permitted parent fragment cannot be located in the existing content hierarchy and attaching the instantiated design fragment to the permitted parent fragment.

4. A system as claimed in any one of the preceding claims, wherein the content hierarchy assembler is arranged to assemble the content hierarchy by attaching the permitted parent fragment to at least one parent fragment above the permitted parent fragment in the hierarchy until all of the instantiated parent fragments are connected to a root fragment of the content hierarchy.

5. A system as claimed in any one of the preceding claims, wherein the plurality of design fragments each comprise attributes specifying one or more parent fragment types to which the design fragment is permitted to be attached in the content hierarchy.

6. A system as claimed in any one of the preceding claims, wherein the content hierarchy assembler is arranged to instantiate each parent fragment with attributes specifying the number of child fragments to which the parent fragment can be attached and/or the type of child fragment to which the parent fragment can be attached.

7. A system as claimed in any of the preceding claims, wherein the content gatherer is co-operable with a source for gathering content from the source into content sub-groups dependent on the content type of the content and the populator is arranged to populate content of each content type into one or more selected design fragments suitable for the content type.

8. A method for generating a content hierarchy for use in laying out content from one or more sources for display, the method comprising:
gathering content from a source;
populating at least one design fragment from a plurality of stored design fragments using the gathered source content, the plurality of design fragments each comprising design parameters specifying how the source content can be laid out; and
assembling the content hierarchy by attaching the populated design fragment to a selected parent fragment permitted for the populated design fragment, the parent fragment containing design parameters specifying how each design fragment can be laid out for display.

9. A method as claimed in claim 8, wherein assembling the content hierarchy comprises locating in the existing content hierarchy a parent fragment permitted for the populated design fragment and/or assembling the content hierarchy comprises instantiating a parent fragment permitted for the populated design fragment if such a permitted parent fragment cannot be located in the existing content hierarchy.

10. A method as claimed in claim 8 or 9, wherein assembling the content hierarchy comprises attaching the permitted parent fragment to at least one parent fragment above the permitted parent fragment in the content hierarchy until all of the instantiated parent fragments are connected to a root fragment of the content hierarchy.

11. A method as claimed in any one of claims 8 to 10, wherein each design fragment when instantiated comprises attributes specifying one or more parent fragment types to which the design fragment is permitted to be attached in the content hierarchy.

12. A method as claimed in any one of claims 8 to 11, wherein the design fragments and content hierarchy comprise logical structures for laying content for display independent of a display surface.

13. A method as claimed in any one of claims 8 to 12, wherein part or all of the content hierarchy describes a specific layout dependent on the properties of a selected display surface.

14. A computer readable medium having a computer program recorded thereon, the program being executable by a computer to carry out the method of any of claims 8 to 13.

15. Computer apparatus comprising a processor programmed to perform the method of any of claims 8 to 13.
